(19) United States
(12) Patent Application Publication
(10) Pub. No.: US 2011/0208542 A1
(43) Pub. Date: Aug. 25, 2011

(54) VOICE OF THE PATIENT SYSTEM

(75) Inventors: Pedro Martinez, Boca Raton, FL (US); Noel J. Guillama, Wellington, FL (US)

(73) Assignee: THE QUANTUM GROUP, INC., WELLINGTON, FL (US)

(21) Appl. No.: 12/921,300

(22) PCT Filed: Mar. 4, 2009
(86) PCT No.: PCT/US09/36019

§ 371 Date: Oct. 26, 2010

Related U.S. Application Data
(60) Provisional application No. 61/033,643, filed on Mar. 4, 2008.

(51) Int. Cl. G06Q 50/00

(52) U.S. Cl. 705/3

(57) ABSTRACT

A computer system adapted to store a record of a patient's data received from at least one of doctor, patient, hospital, therapist, wherein the data is in at least one format selected from audio, visual, text, and wherein a patient can access the patient's own record and optionally add comments in one of said formats is disclosed. Also disclosed is a method of storing patient's data, comprising inputting data from at least one of doctor, hospital, or therapist in at least one format selected from audio, visual, text and authorizing the patient to access that patient's record so that patient can review the accuracy of the data and to input additional data or corrected data in one of said formats if the patient wishes to add comments to the record.

### CROSS-REFERENCE TO RELATED APPLICATIONS

Benefit of U.S. Provisional patent application 61/033,643, filed Mar. 4, 2008, is claimed. Said provisional application is hereby incorporated by reference.

### BACKGROUND OF THE INVENTION

This invention relates to the field of medical systems, and more particularly to a system for comprehensively capturing, storing and managing the patient input and doctor/patient interaction in a variety of electronic formats thereby reducing the potential of miscommunication between doctor and patient.

Doctor/Patient visits are often documented in a variety of different forms and images. These are stored in a variety of different medical folders. Yet the critical information of the doctor/patient interaction is limited to a set of handwritten notes transcribed for later review. This represents the doctor's conclusions. Rarely does the patient review these notes for information, accuracy or consistency. Rarely does a patient record their own conditions beyond the initial pre-screening form in the reception room. Therefore, the patient does not play a significant role in the treatment selection.

There has been a considerable amount of research dedicated to the issue of the role of the patient in selecting a treatment choice. Studies indicate that patients tend to value their doctor's recommendations more in cases with more severe or life-threatening conditions. However, patients generally wish to take part in medical decisions concerning their health.

In hospitals and other health care environments, it is often necessary or desirable to collect and display a variety of medical data associated with a patient. Such information may include laboratory test results, care unit data, diagnosis and treatment procedures, attending physician or health care provider or related information associated with a patient. Presently, such information is often provided via a chart attached to a patient's bedside or at an attendant's station. However, such physical charts are cumbersome to view, and often do not include the most up-to-date medical information associated with the patient.

Therefore, what is needed is a system that allows comprehensive and multimedia input by a patient into their health record.

### SUMMARY OF THE INVENTION

The present invention provides a solution to the above problems, and it is an object of the present invention to provide a system and method designed to comprehensively capture, store and manage the patient input and doctor/patient interaction in a variety of electronic formats. These provide a richer dimension to the patient's health record by capturing their own words and those of the attending doctor. The system reduces the potential he said/she said by capturing the exchange in a variety of different media. The system has the unique ability to integrate critical information from a patient's perspective into their own record in a private, secure and automated fashion. This patient input will enhance the completeness of the record and its presentation for future review by the patient, doctor or related third parties. This system reduces the potential for miscommunication between doctor and patient and provides an exact account of the transaction.

It is a further object of the present invention to provide a documentation system that can be used in retrospect by the patient to review their records and assure completeness.

It is yet another object of the present invention to provide a documentation system that can also be used by the doctor to further vividly review a given case.

It is another object of the present invention to provide a documentation system that can be reviewed by a third party that may be asked to pass judgment on a given transaction.

According to one aspect of the present invention, there is provided a computer system comprising a patient portal, a doctor portal and a plurality of terminals communicatively coupled to a universal health record management system. The patient input is compiled from any of the terminals located in various points of service, i.e., the hospital, the therapist.

According to a further aspect of the present invention, there is provided a documentation system that integrates text, audio, image and video files into the patient's electronic health records. The system and methods provide for a more comprehensive capture of the patient's input related to their conditions. This approach provides a greater knowledge base for doctors, the opportunity for patients to dynamically explain their conditions and a historical file of the doctor/patient interaction. These files are used by the patient to review their records and assure completeness.

According to another aspect of the present invention, there is provided a system that increases the amount and quality of information captured at a doctor/patient visit, reduces potential errors by providing both patient and doctor the ability to review the record, improves the patient's understanding of their assessment by providing them a method to replay the doctor's analysis and recommendations.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an embodiment of the patient documentation system;

FIG. 2 is a flow chart of the patient documentation system according to this invention;

FIG. 3 is a typical patient input set-up according to this invention;

FIG. 4 is a flow chart of the operations of an embodiment of the patient documentation system of the present invention.

### DETAILED DESCRIPTION OF PREFERRED EMBODIMENTS

Preferred embodiments of the present invention will be described in detail herein below with reference to the accompanying drawings. In the following description, well-known functions or constructions are not described in detail since they would obscure the invention with unnecessary detail.

The Voice of the Patient System establishes a uniform and versatile method for continuous monitoring and communication of patient's health and care. It establishes both process and automation with related potential quality and productivity improvements.

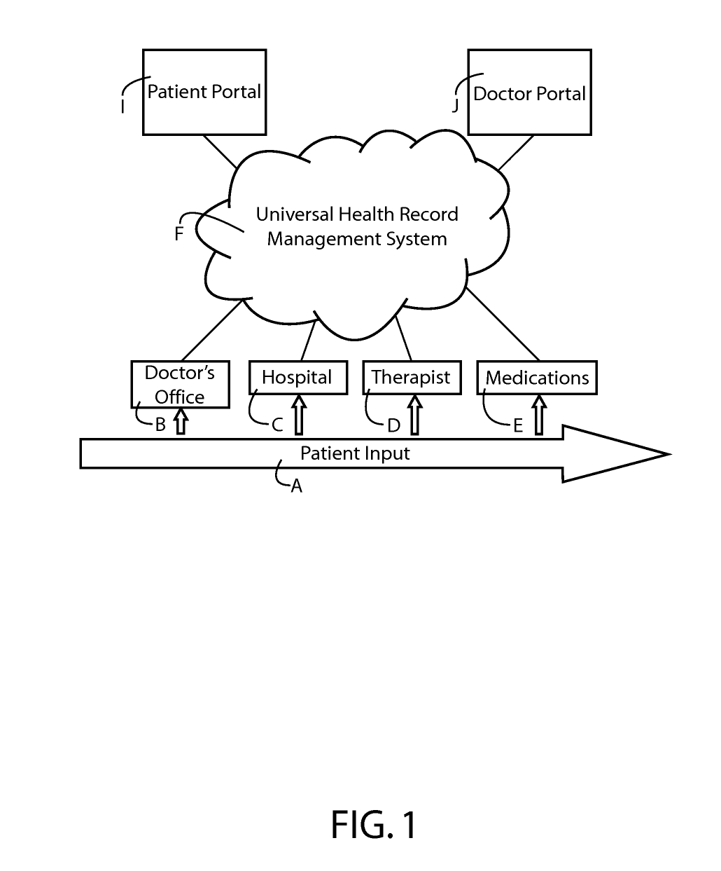

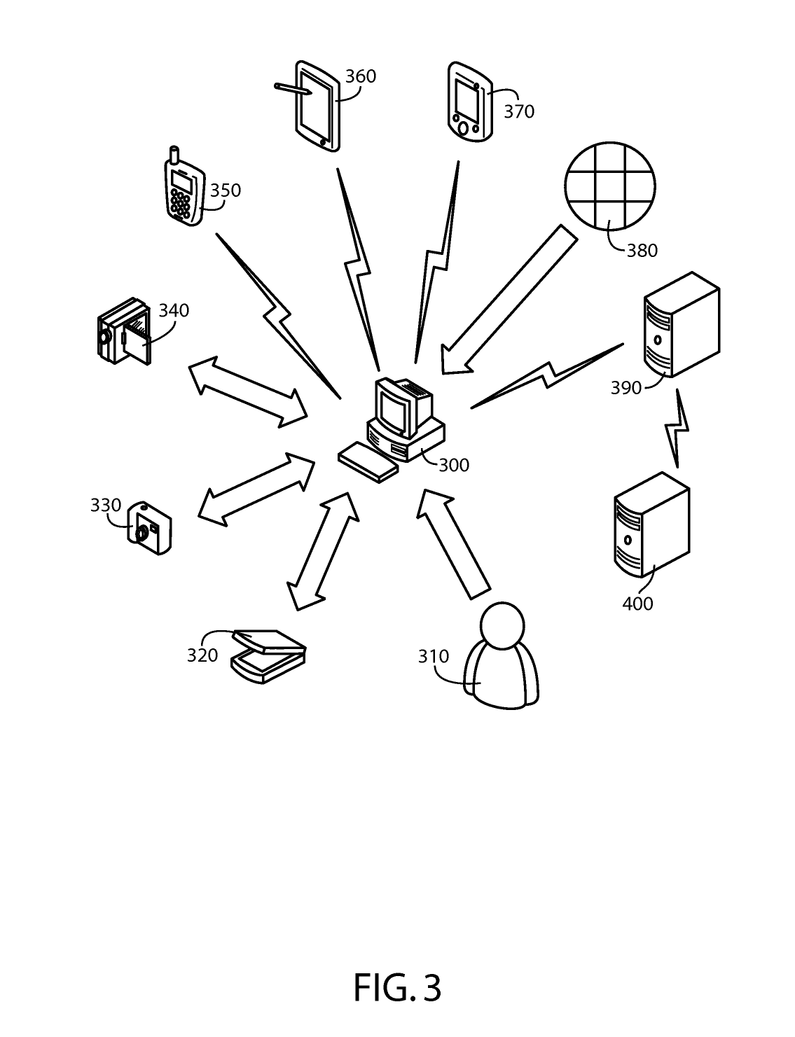

FIG. 1 shows the different components of the patient documentation system. FIG. 3 shows a typical patient input set-up described as item (A) in FIG. 1. Patient 310 completes forms (paper or electronic). Patient's input may also be audio recorded, video recorded in pre-established electronic template customized and implemented by the doctor. These electronic templates may be implemented using a scanner 320, a digital camera 330, a video camera 340, a smart phone 350, a tablet computer 360, a PDA 370, an audio device 380 or any other suitable device.

In FIG. 1, the patient input (A) is captured during a visit to doctor's office (B), hospital (C), therapist (D) and medication (E) providers. This is accomplished in electronic format through pre-established electronic forms, paper forms scanned into electronic, audio and/or video recordings. These allow the patient to graphically and comprehensively describe conditions beyond what can be captured in a form. This method also facilitates review the of record post-visit by the doctor or patient. The different patient inputs are transferred to a universal health record (UHR) management system (F).

The UHR management system provides the formatting, data transfers, time stamping, storage, privacy and security of the patient's records. It electronically catalogues the information for further access by the patient or doctor through electronic portals (I) and (J). This system establishes a uniform, structured and secure method for automated transfer of critical, sensitive and timely information. Authentication may be performed by the UHR management server or it may be separately implemented.

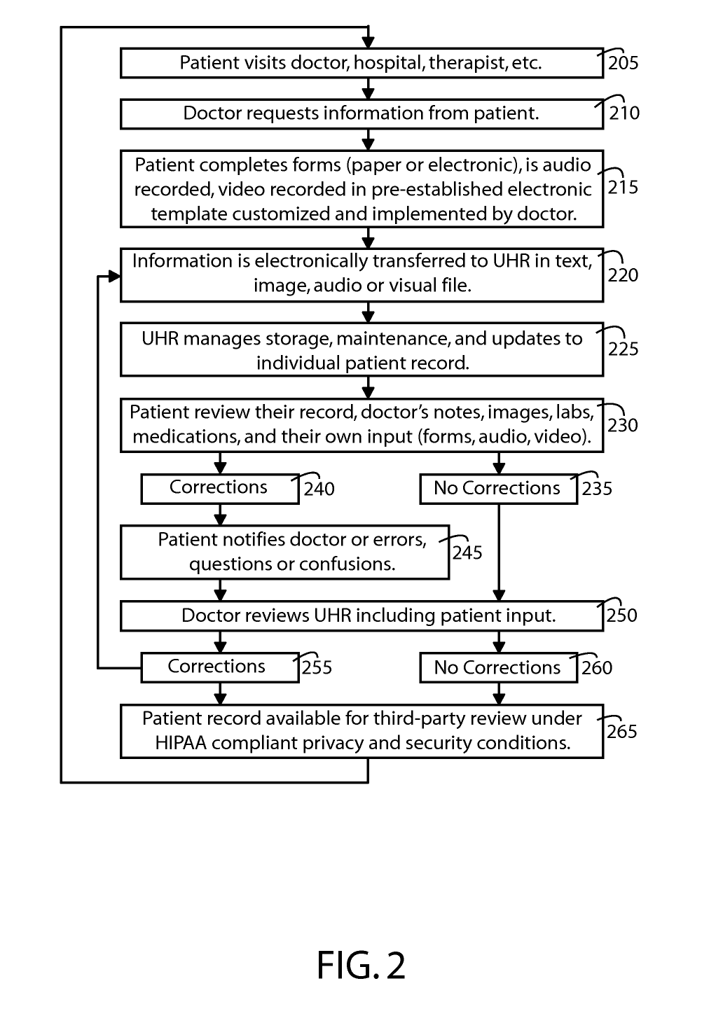

In one embodiment as shown in FIG. 2, a patient visits their doctor's office, hospital, therapist or other point of care (205). The doctor inquires about conditions, treatments and related information (210). The patient response information is electronically captured in a variety of possible media at a point of care (215). The patient can fill out the pre-screening form at an interactive touch-sensitive or voice recognition kiosk or from home. The doctor electronically captures and records the visit including questions, patient responses, areas where patient points to, vagueness or precision of answers, physical reaction, etc.

The electronic information from the visit is transferred to the UHR management system (220) where it is time stamped and securely stored (225). Remotely and after the visit, the patient and doctor can separately review the record of the visit (230) for accuracy, completeness and further understanding of what was said, done and recommended. If a patient has corrections, questions or clarifications (240), he or she can send them electronically to the doctor (245). The doctor can then review the concerns and update per the patient's input and as necessary (250). If there are no corrections (260), the record stays as is. If there are corrections by the doctor (255), the record is updated (220) as required. The patient record is available for third-party review in compliance with Health Insurance Portability And Accountability Act (HIIPA) privacy and security conditions (265). The patient may order a copy of the record for their archives.

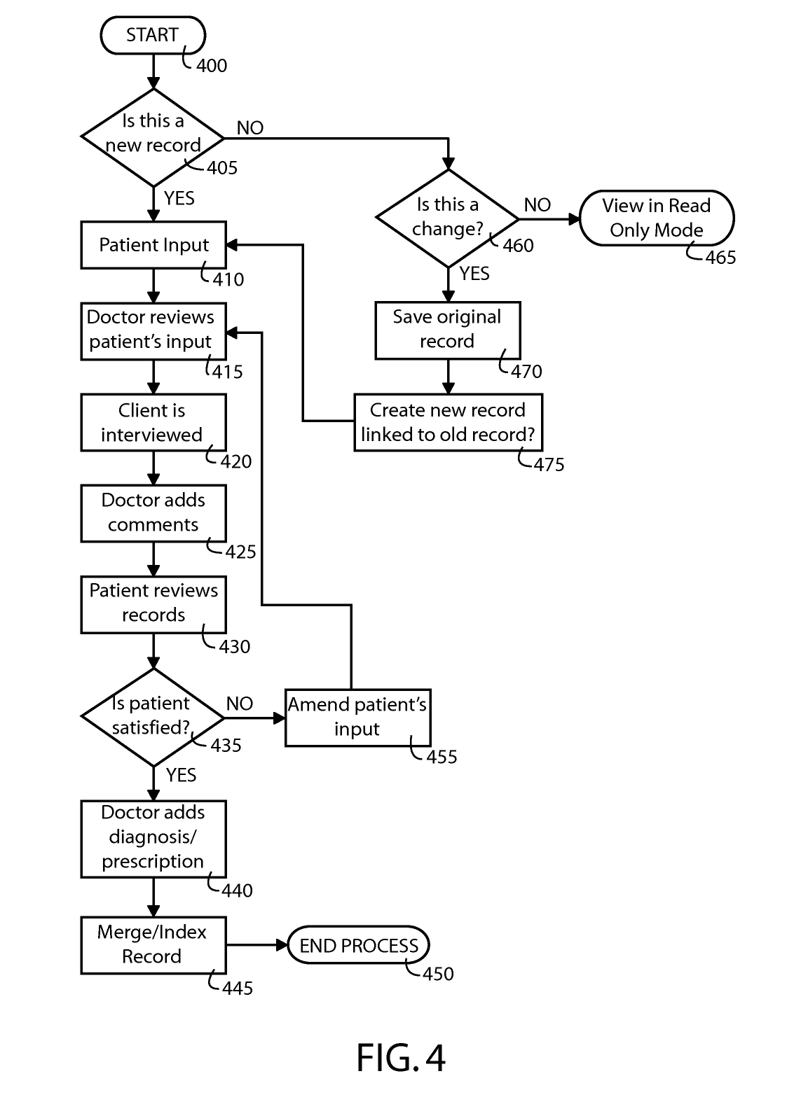

FIG. 4 shows an operational flowchart of the system. In step 405, the system checks whether this is a new record or not. If it is a new record, step 410 is executed; otherwise step 460 is executed instead. In step 410, the patient's input is captured. In step 415, the doctor reviews the patient's input. In step 420, the patient is interviewed by the doctor. In step 425, the doctor adds his/her comments. In step 430, the patient reviews the records. In step 435 if the patient is satisfied, step 440 is executed whereas if the patient is not satisfied step 455 is executed where the patient input is amended according to patient's feedback. In step 440, the doctor adds diagnosis/prescription to the record. In step 445, the record is indexed and in step 450, the operation ends.

If the answer in step 405 is “no,” step 460 is executed where it is determined if the inquiry pertains to a change. if it's not a change, then the record is displayed in “Read Only Mode.” If it is a change, in step 470 the original record is saved. In step 475, a new record linked to the saved record is created and step 410 is executed. A patient record cannot be changed without the patient signing off on the change.

The patient record is available in some embodiments for third party review (i.e., referral doctors, specialists, educators, dispute resolution and historical evidence) (M). The cycle is repeated dynamically as required by different doctor/patient visits.

Although the preferred embodiments of the present invention have been disclosed for illustrative purposes, an artisan of ordinary skill in the art will readily understand that various modifications, additions and substitutions are possible, without departing from the scope and spirit of the invention as further defined by the accompanying claims.

What is claimed is:

1. A computer system adapted to store a record of a medical data related to a patient inputted from a doctor, hospital, or therapist in at least one format selected from audio, visual, and text, configured to authorize the patient to access the patient's own record and add comments in at least one of said formats.

2. The system of claim 1, further comprising a patient's portal.

3. The system of claim 1, further comprising a a doctor's portal.

4. The system of claim 1, further comprising a report generator.

5. The system of claim 1, further comprising a plurality of providers communicatively coupled to the computer system where the patient's input is captured.

6. The system of claim 1, wherein a patient's portal further comprises any device with access to the Internet.

7. The system of claim 1, wherein a doctor's portal further comprises any device with access to the Internet.

8. The system of claim 1, wherein the system allows comprehensive and multimedia input by a patient into their health record, and establishes a uniform, structured and secure method for automated transfer of critical, sensitive, and timely information.

9. The system of claim 4, wherein the system further provides one of formatting, time stamping, storage, privacy and catalogues the information for further access by the patient, doctor, approved third party.

10. The system of claim 1, wherein a patient's record cannot be changed without the patient's authorization.

11. A method of storing and controlling access and authorization to change medical records comprising creating a patient record; storing in the record on a web server patient data received from at least one of doctor, hospital, or therapist in at least one format selected from audio, visual, text; and authorizing the patient to access the patient's record, review the accuracy of the data, and input corrected data or comments on the stored medical data in one of said formats.

12. The method of claim 11, comprising storing the data in audio format.

13. The method of claim 11, comprising storing the data in visual format.

14. The method of claim 11, further comprising restricting changes to the patient's record and requiring the patient's authorization to change the record.

15. The method of claim 11, further comprising generating a report of the patient's record.

16. The method of claim 11, further comprising authorizing audio and video input by a patient into their health record, establishing a uniform, structured and secure method for automated transfer of critical, sensitive and timely information.

17. The method of claim 15, further providing formatting, time stamping, storage, privacy and cataloguing the information for further access by the patient, doctor, approved third party.

18. The method of claim 11, wherein a patient's record cannot be changed without the patient's authorization.

19. The method of claim 11, further comprising a providers' module.
